(19) United States
(12) Patent Application Publication
(10) Pub. No.: US 2010/0205214 A1
(43) Pub. Date: Aug. 12, 2010

(54) Method for Creating Virtual Compound Libraries Within Markush Structure Patent Claims

(75) Inventors: Anton Fliri, Stonington, CT (US); Erwan Moysan, Les Clayes Sous Bois (FR); Matthias Nolte, Amston, CT (US)

Correspondence Address: BUCHANAN, INGERSOLL & ROONEY PC, POST OFFICE BOX 1404, ALEXANDRIA, VA, 22313-1404, US

(73) Assignee: DecrIPt Inc., New London, CT (US)

(21) Appl. No.: 12/632,139

(22) Filed: Dec. 7, 2009

Related U.S. Application Data
(60) Provisional application No. 61/120,151, filed on Dec. 5, 2008.

(51) Int. Cl. G06F 17/30

(52) U.S. Cl. 707/780; 707/E17.014

(57) ABSTRACT

A machine-implemented method creates collections of chemical structures exhibiting a certain degree of structural similarity with exemplified compounds. Specific examples are extracted from a patent. Molecular structure fingerprints are calculated for the specific examples. Markush structure topology information is obtained from a patent database. Virtual libraries are enumerated using the Markush structure topology information extracted from the database. Molecular structure fingerprint similarity of exemplified compounds is identified by comparing the fingerprints with the molecular fingerprints calculated from a randomly enumerated set of chemical compounds. A subset of randomly enumerated chemical structures, which exhibit a similarity range within a user specified similarity range with the fingerprint calculated from the exemplified compounds, is then selected.

### FIELD OF THE INVENTION

This disclosure relates to the analysis, characterization and comparison of general chemical structure descriptions, and more particularly to the identification of compounds that exhibit properties that are similar to those of specifically claimed compounds in composition of matter patents or compounds exemplifying the scope of general chemical structure descriptions.

### BACKGROUND

Research activities conducted world wide and published daily in many foreign language journals are stretching the capacities of current patent examination systems. In response, many national and international patent systems are undertaking initiatives for evaluating changes to current patent practice. Among these changes are proposals that patent applicants should have the burden of not only identifying and submitting prior art deemed material to patentability, but also pointing out how an invention is patentable over prior art references. For instance, the U.S. Patent & Trademark Office considered placing additional requirements on the submission of Information Disclosure Statements (IDS) and to require patent applicants to specifically point out the relevant passages in prior art references that are material to the patentability of the invention. While such proposed rule changes are not currently in effect, initiatives of this nature will impose substantial new analytical burdens on patent applicants seeking to bring information to the attention of the national and international patent examination offices.

Accordingly, analysis of prior art associated with the protection of intellectual property-based investment activities is expected to increase in importance for research-based investment activities. Moreover the creation of strong intellectual property protection for products is of particular importance for the chemical and biochemical industry, with its long product development cycles. For complying with disclosure requirements, this industrial sector is confronted with the problem of deciphering prior art encoded by generic chemical structure representations, also frequently called Markush structures. Unfortunately, current methods for analysing Markush structure based prior art information are time consuming and error-prone. For addressing these shortcomings, U.S. Patent Application Publication No. 2009-0132464 describes a Markush structure enumeration technology. The present invention, in combination with that technology, improves the speed and accuracy of ascertaining intellectual property information in the form of Markush structure representations, and/or other derivative forms of representation, appearing in chemical composition of matter patents and patent databases.

### SUMMARY

Briefly, a machine-implemented method creates collections of chemical structures exhibiting a certain degree of structural similarity with exemplified compounds. Specific examples are extracted from a patent or a derivative form of this information stored in a patent database. Molecular structure fingerprints are calculated for the specific examples. Markush structure topology information is obtained from a patent database. Virtual libraries are enumerated using the Markush structure topology information extracted from the database. Molecular structure fingerprint similarity of exemplified compounds is identified by comparing the fingerprints with the molecular fingerprints calculated from a randomly enumerated set of chemical compounds. A subset of randomly enumerated chemical structures, which exhibit a similarity range within a user specified similarity range with the fingerprint calculated from the exemplified compounds, is then selected.

### BRIEF DESCRIPTION OF THE DRAWINGS

FIG. 1 is a general flow chart of a procedure for determining the content of general chemical structure descriptions; and

FIG. 2 is a schematic diagram of a system for creating a collection of compounds that exhibit structural similarity.

### DETAILED DESCRIPTION

It is common practice to use general chemical structure representations in descriptions of property or utility information associated with compositions of matter. These general chemical structure renderings, characterizing compositions of matter, generally consist of descriptions for changing:
1. the atom constitution of chemical structure scaffolds (genus) and/or
2. structure fragments with different properties (substituent groupings) attached to a common structure core.

Since these general chemical structure descriptions provide an efficient method for describing variations of composition of matter with similar properties, these general chemical structure renderings are frequently used in patent applications and more generally also for the capturing of structure property relationship information associated with structurally related chemical compositions. See, e.g., Markush E. A., U.S. Pat. No. 1,506,316, Aug. 26, 1924.

Depending on the number of attachment points in a given genus, this process usually yields a multiplicity of starting points each having a discrete molecular architecture. Discrete species (single compounds) can then be created from any one of these starting points by successively attaching fragments with specific molecular topology in accordance with the claim language of a patent. This process is repeated for each attachment point until all the conditions defined by a patent's claim language are exhausted (See e.g., John M. Barnard, Geoff M. Downs, Annette von Scholley-Pfab and Robert D. Brown Journal of Molecular Graphics and Modeling, Volume 18, Issues 4-5, 2000, Pages 452-463).

This evaluation frequently requires interpretation of open-ended and indefinite terminology that is used for describing collections of chemical structure fragments with similar physiochemical properties. For example, the generic term “alkyl” describes an infinite number of arrangements between an infinite number of carbon atoms each bearing potentially four different combinations of substituents with variations in chain lengths and carbon atom arrangements. Likewise the generic term “heteroaryl” encodes a near infinite number of aromatic carbon-based ring systems each containing one or more hetero atoms. (See e.g., Burton A. Leland et. al. J. Chem. Inf. Comput. Sci.; Volume 3, Issue, 1997, pages 62-70).

Adding to the complexity of interpreting the meaning of these chemical topology descriptors, the claim text in patents frequently restricts the scope of these indefinite terminologies by defining discrete subsets of these terminologies in a non-standardized way. The definitions of these subsets, in turn, may not only be influenced by an inventor's motive to identify specific structure property relationship, but also by requirements imposed by patent law. Moreover, for providing enabling experimental details for manufacturing various embodiments encoded by general chemical structure representation, an inventor provides in patent claims the chemical structure information for a limited number of specific structure examples usually reflecting the structural diversity of the broader Markush structure claim.

Because of the complexities involved in comparing chemical matter defined by different Markush structure claims, these comparisons often involve inspection of specific structure examples for obtaining clues for possible interpretations of Markush structure claims. However, because general chemical structure descriptions frequently encode a great number of different structure-fragment combinations and are composed in a manner that may even obscure the structural diversity of their encoded content, the inspection of each and every chemical structure that is specifically claimed in chemical patents, and application of this information for understanding structure property relationships encoded by the corresponding Markush structure, is very time consuming and error prone. Thus the analysis of prior art associated with chemical composition of matter patent applications represents one of the most resource-consuming activities in analysis of chemical patent information. Moreover, since the production of mental enumeration results is a tiring, time consuming and error-prone process, it is well recognized that mistakes made during the examination of chemical composition of matter patents affect the quality and value not only of the claimed intellectual property, but also of the extracted structure function information.

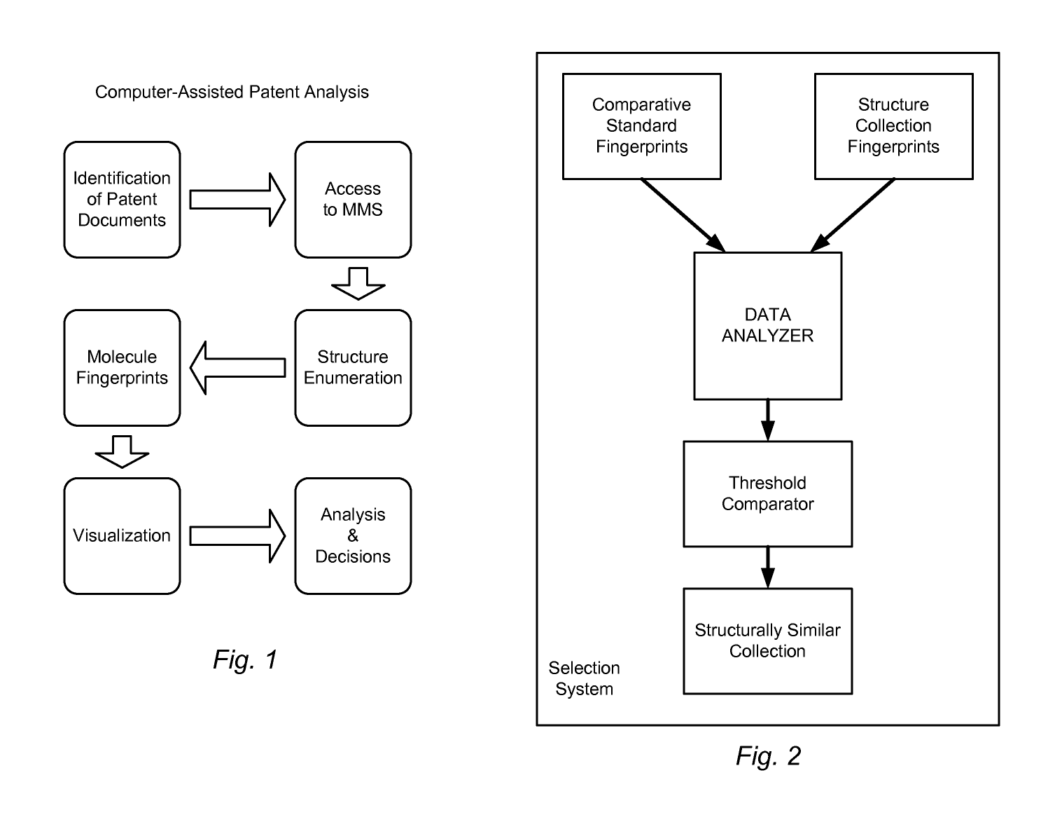

For addressing this bottleneck in analysis of chemical patent information, the previously-noted '464 patent application publication discloses a machine-implemented method for determining the content of general chemical structure descriptions. With reference to the general flow diagram of FIG. 1, patent documents relevant to a query are identified. The chemical structures described in these documents are characterized and compared using the following:
(1) Methods for recognizing open-ended and indefinite terminologies in substituent definitions of Markush structure (MKST) stored in commercial patent databases such as, for example, the Derwent, MMS and Marpat databases;
(2) Methods and strategies for replacing these open-ended and indefinite variables in MKST definitions with finite and well defined structure fragments that are within the scope of patent claims;
(3) Methods for recognizing valence variations of attachment points or valence variations of structure fragments in substituent definitions of MKST stored in commercial patent databases;
(4) Methods for replacing these variable attachment points with collections of chemical structure fragments that are within the general scope of patent claims;
(5) Methods for enumerating MKST;
(6) Methods for converting enumerated structure examples into molecular fingerprints characterizing the exact chemical structure of enumerated compounds;
(7) Methods for computing the chemical structure fingerprint similarities of enumerated compounds; and
(8) Methods for associating chemical structure fingerprint similarities with inventions and prior art reference patent documents of interest.
   For further details regarding each of these methods, see U.S. Patent Application Publication No. 2009/0132464, the disclosure of which is incorporated herein by reference.

Thus, using prior art search results, such as patent numbers provided by an end-user, the previously disclosed process retrieves the corresponding Markush information from databases such as MMS (hosted by Questel), Derwent and/or Marpat, and uses a random enumeration strategy for creating structure samples representing the structural diversity specified in the MKST claims of the input patent list. The output results of this enumeration process are chemical structure files in SDF format that can be analyzed using standard statistical software and visualization packages such as Spotfire® or the Windows-compatible platform MPX.

While the previously disclosed process facilitates the content comparison of general chemical structure descriptions, the employed random enumeration process creates in many instances extremely large data sets. Moreover, a very large number of the randomly enumerated molecules exhibit molecular properties that are very dissimilar to those exhibited by the specific examples provided by an inventor in a patent. Since interpretation of structure function or prior art relationships associated with patent information is most accurate for molecules exhibiting properties that are most similar to those exhibited by the specifically claimed compounds, it is desirable to restrict the analysis of structure function information described in composition of matter patents to a collection of molecules exhibiting a high degree of molecular property or structural similarity with those exhibited by the specifically claimed (exemplified) compounds. Thus, one aspect of this invention is a machine-implemented method for creating collections of chemical structures exhibiting a certain degree of structural similarity with exemplified compounds.

More particularly, the method comprises the following steps:
(1) extracting the inventor-provided specific examples associated with a patent from a patent database;
(2) calculating molecular structure fingerprints for the specific examples, for example, in a computer using the algorithms of the '464 published application;
(3) extracting the Markush structure topology information from a patent database;
(4) enumerating virtual libraries using the Markush structure topology information extracted from the database by means of a computer, for example, in accordance with the procedures of the '464 published application;
(5) identifying molecular structure fingerprint similarity of exemplified compounds by comparing the fingerprints with the molecular fingerprints calculated from a randomly enumerated set of chemical compounds; and
(6) selecting a subset of randomly enumerated chemical structures exhibiting a similarity range within a user specified similarity range with the fingerprint calculated from the exemplified compounds.

It is anticipated that enumerated compound collections exhibiting structural similarity above a certain threshold, such as 80%, in comparison with specifically claimed compounds have the highest probability of falling within the boundaries of patent claims. Accordingly, by determining the degree of similarity of the fingerprints, it becomes possible to check the quality of Markush structure topology information in patent databases and the quality of Markush structure enumeration processes by determining the number of enumerated chemical structures exhibiting a certain degree of structural similarity with the exemplified structures in the pertinent patent claim. For example, if the number of enumerated compounds exhibiting <80% structural similarity in comparison with specifically claimed compounds falls below an certain threshold e.g., when <0.1% of the enumerated molecules exhibit similarities of <80% with the comparative standards, then inspection of the corresponding Markush structure or the pertinent enumeration results may be appropriate. Moreover, compound collections exhibiting a high degree of chemical structure similarity with specifically claimed compounds have utilities for precise analysis of structural property relationships for compounds encoded by Markush structures in chemical composition of matter patent claims. Accordingly, enumerated compound collections with “high” molecular property similarity in comparison with specific exemplified compounds have utilities for identifying and selecting general molecular scaffolds that are capable, upon enumeration, of producing molecules that fall within certain molecular property boundaries.

A system for selecting collections of chemical structures that are structurally similar to a given set of compounds is depicted in FIG. 2. The inputs to the system comprise two sets of fingerprints. These fingerprints are typically chemical structure fragment based. For example, they could be “Isis” structure keys, “Scitegic” structure keys, or any other published “atom pair” or chemical structure or molecular property fingerprints. One set of fingerprints constitutes a comparative standard, and corresponds to the exemplary compounds of interest, e.g. specific examples disclosed in a given patent. The second set of fingerprints are those which are created from collections of chemical structures, e.g. derived through enumeration of Markush structure topology descriptors in a database, such as the MMS, Derwent, or Marpat database, or derivatives thereof, pursuant to the computer-implemented procedures of the '464 published application.

The similarity between a fingerprint of the comparative standard and the fingerprints of members in a collection is determined. This determination starts out with the selection of an appropriate similarity measure such as, for example, “cosine correlation, Euclidean distance”, Tanimoto coefficient, or any other similarity value. Each element of the chemical structure fingerprint of the comparative standard is compared with each element of the chemical structure fingerprint of a reference sample. These comparisons determine the distance between each fingerprint element using the appropriate similarity measure and by calculating the “average” distance by considering the distance between all fingerprint elements. The algorithm that can be used for these calculations varies depending on the selected similarity measure. Known data analysis and visualization programs can be used to calculate the degree of similarity between fingerprints. One example of a commercially available program that can be used to calculate these values is Spotfire®, distributed by Tibco Software, Inc. Thus, the procedure of the invention can be implemented on a computer that is programmed to execute such a data analysis and visualization program.

Likewise, the scale for expressing measures of fingerprint similarity depends on the selected similarity measure. For example, using the similarity measure “cosine correlation” in these calculations, the output values will range between zero (0) and one (1). The value one (1) identifies the highest similarity value between the fingerprints of two samples. In this case, the two samples are identical and the similarity is 100%. A similarity measure value of zero (0) would be used to express the least similarity. Using “cosine correlation” for fingerprint comparison, one typically observes that chemicals sharing similarity values of greater than 0.8 (80% fingerprint similarity) can be identified as having similar chemical architecture, and chemicals with similarity values of less than 0.5 designated as having dissimilar chemical architecture. Once the similarity results have been determined for a collection of compounds, therefore, the results can be compared to a predetermined threshold value within the computer, e.g. 0.8. A collection having a high percentage of similarity results that equal or exceed that value, e.g. more than 99% of the results meet the threshold, can be labelled as being structurally similar to the comparative standard, such as for example, specific compounds claimed in a given patent or compounds with desirable utilities, functions or properties. This collection can be separately stored in memory as a library of compounds having the noted attributes.

Accordingly using appropriate fingerprint similarity measures allows one to assess molecular property or chemical structure relationship of chemicals in sample collections. For example, a sample collection containing structures sharing similarity values of greater than 0.8 (as determined by “cosine correlation”) can be designated as containing structurally related molecules. It is also generally observed that structurally related molecules have similar physio-chemical and biological properties. Accordingly the fingerprint similarity between chemical structures provide estimates for the property similarity between compound collections. Of course, a different threshold value, e.g. 0.75 or 0.85, might be chosen in dependence upon the application for which the compounds are to be used, and/or the desired similarity of properties.

Accordingly, chemical structure fingerprint similarity measures can be used for assessing the relevance of prior art in chemical composition of matter patents. For example, if chemicals in compound collection (X) share fingerprint similarity values of greater than 0.8 (as determined by “cosine correlation”) with the fingerprints of claimed compounds in a comparative reference patent, then compound collection (X) contains molecules that have similar chemical architecture and hence likely also similar physio-chemical and biological properties. Accordingly the properties associated with compounds claimed in the reference patent can be used to anticipate the properties of compounds in collection (X). Accordingly determination of fingerprint similarity between compound collections and prior art patents can be used for assessing the patentability of inventions. Moreover, fingerprint similarities between compound collections exceeding values of greater than 0.8 (as determined by “cosine correlation”) can be used for identifying if new compound collections have commercial value by using, as comparative standards, a collection of known compounds with high commercial value.

Accordingly, the disclosed process is useful for rendering molecular property information disclosed in the form of general chemical structure descriptions that are comparable. It will be apparent to those skilled in the art that this process enables the rendering of molecular property information disclosed in patent databases such as for example, national or international patent databases, the MMS database, the Marpat database or derivatives of these databases in comparable form. It will also be apparent that these comparisons may also be performed by using as comparative standards an end-user defined collection of compounds. This process is useful for increasing the efficiency of new molecular structure design by enabling one to take advantage of structure function information encoded in the form of general chemical structure descriptions in patent databases. It also provides a tool for conducting quality control analysis of the construction of a database, to ensure that compounds having similar attributes are properly grouped with one another.

1. A method for creating collections of chemical structures exhibiting a predetermined degree of structural similarity with exemplified compounds, comprising:
(a) extracting specific examples of chemical structures;
(b) calculating molecular structure fingerprints for the specific examples;
(c) extracting Markush structure topology information from a database;
(d) enumerating virtual libraries using the Markush structure topology information extracted from said database;
(e) calculating molecular fingerprints from an enumerated set of chemical structures;
(f) identifying molecular structure fingerprint similarity of exemplified compounds by comparing the fingerprints for the specific examples with the fingerprints for the enumerated set of chemical structures; and
(g) selecting a subset of said enumerated chemical structures that exhibit a similarity range within a predetermined range of similarity with the fingerprints calculated from the exemplified compounds.

2. The use of the method according to claim 1 for constructing chemical compound libraries.

3. The use of the method according to claim 2 for conducting structure/molecular property relationship analysis.

4. The use of the method according to claim 1 for conducting quality control analysis of patent databases construction.

5. The use of the method according to claim 1 for determining the relevance of prior art composition of matter patents in regard to new inventions.
